(19) United States
(12) Patent Application Publication
(10) Pub. No.: US 2018/0260835 A1
(43) Pub. Date: Sep. 13, 2018

(54) METHOD AND SYSTEM FOR PREMIUM DEBIT CASH REWARDS AND LIFESTYLE MANAGEMENT

(71) Applicant: Bippy M. Siegal, NY, NY (US)

(72) Inventor: Bippy M. Siegal, NY, NY (US)

(21) Appl. No.: 15/919,266

(22) Filed: Mar. 13, 2018

Related U.S. Application Data
(60) Provisional application No. 62/470,545, filed on Mar. 13, 2017.

(51) Int. Cl. G06Q 30/02

(52) U.S. Cl. CPC G06Q 30/0226; G06Q 40/02; G06Q 30/0236

(57) ABSTRACT

A method and system for an infrastructure and intelligence service for a premium debit cash rewards and a lifestyle management network. Members of the lifestyle management network experience exclusive rewards tailored by the lifestyle management group. Members earn exclusive rewards based upon transactions made with a debit rewards card.

### PRIORITY

This application claims priority to U.S. Provisional application No. 62/470,545, filed Mar. 13, 2017, which is hereby incorporated by reference as if submitted in its entirety.

### FIELD OF THE INVENTION

The present invention relates to brand loyalty management, and, more particularly, a debit card cash reward system and lifestyle account management infrastructure.

### BACKGROUND

Debit card usage in the United States has grown dramatically in recent years. Between 2000 and 2012 alone, the number of debit card transactions grew from 8.3 billion to 47 billion. On average, U.S. financial institutions issue 165 million new debit cards every year.

While ATM usage has dropped from 3.4 monthly withdrawals in 2005 to 2.0 monthly withdrawals in 2014, debit card usage has increased at the point-of-sale. Statistics show that more debit cardholders are using their cards to get cashback when making purchases and the average cashback amount in 2012 was $33.10.

Debit card usage has become increasingly common for everyday usage, such as grocery shopping, at gas stations, and at restaurants. Consumers prefer credit card usage while online shopping, however debit card usage has increased in this area as well.

Thus, there exists a need for a debit card which may provide robust benefits for users and provides an economic advantage for vendors and others who may accept such a card to process an exchange of value.

### BRIEF SUMMARY OF THE INVENTION

The present invention provides a method and system for an infrastructure and intelligence service for a premium debit cash rewards and a lifestyle management network. Members of the lifestyle management network may experience exclusive rewards tailored by the lifestyle management group. Members may earn exclusive rewards based upon transactions made with a debit rewards card.

The present invention provides a computer-implemented engine for generating a reward, over a network, responsively to input member information comprising at least one certified member input, comprising a graphical user interface capable of locally querying a reward engine for the input member information comprising at least general member information, member financial information, and the at least one certified member input, at least one network port capable of remotely receiving the member information from said graphical user interface, at least one rules engine communicatively connected to said at least one network port, and comprising a plurality of rules to generate, responsively to the input member information, at least one verified reward, and at least one notification engine communicatively connected to at least one rules engine for reporting to a member at least one verified reward, wherein member access is provided on a subscription basis.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 is a block diagram of an exemplary computing system for use in accordance with herein described systems and methods;

FIG. 2 is a block diagram showing an exemplary networked computing environment for use in accordance with herein described systems and methods; and

FIG. 3 is a block diagram illustrating an embodiment of the present invention.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

Embodiments are provided throughout so that this disclosure is sufficiently thorough and fully conveys the scope of the disclosed embodiments to those who are skilled in the art. Numerous specific details are set forth, such as examples of specific components, devices, and methods, to provide a thorough understanding of embodiments of the present disclosure. Nevertheless, it will be apparent to those skilled in the art that certain specific disclosed details need not be employed, and that exemplary embodiments may be embodied in different forms. As such, the exemplary embodiments should not be construed to limit the scope of the disclosure. As referenced above, in some exemplary embodiments, well-known processes, well-known device structures, and well-known technologies may not be described in detail.

The terminology used herein is for the purpose of describing particular exemplary embodiments only and is not intended to be limiting. For example, as used herein, the singular forms “a,” “an,” and “the” may be intended to include the plural forms as well, unless the context clearly indicates otherwise. The terms “comprises,” “comprising,” “including,” and “having” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

When an element or layer is referred to as being “on,” “engaged to,” “connected to,” or “coupled to” another element or layer, it may be directly on, engaged, connected or coupled to the other element or layer, or intervening elements or layers may be present, unless clearly indicated otherwise. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). Further, as used herein the term “and/or” includes any and all combinations of one or more of the associated listed items.

Yet further, although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer, or section without departing from the teachings of the exemplary embodiments.

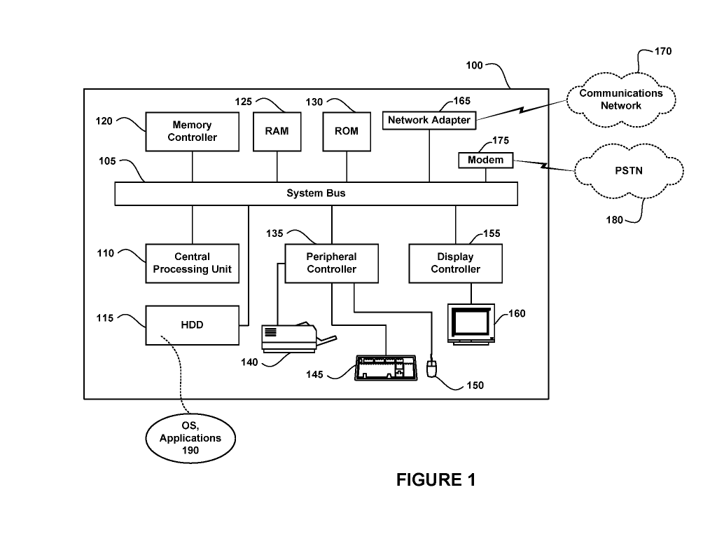

FIG. 1 illustrates an exemplary embodiment of a computer processing system 100 that may receive the various inputs as discussed herein, such as from local or remote sensors or GUIs, and that may perform the processing and logic discussed throughout. That is, the exemplary computing system 100 may be used in accordance with herein described systems and methods.

Computing system 100 is capable of executing software, such as an operating system (OS) and one or more computing applications 124. The software may likewise be suitable for operating hardware, such as via inputs/outputs (I/O), using said applications 124.

The operation of exemplary computing system 100 is controlled primarily by computer readable instructions, such as instructions stored in a computer readable storage medium, such as hard disk drive (HDD) 122, optical disk (not shown) such as a CD or DVD, solid state drive (not shown) such as a USB “thumb drive,” or the like. Such instructions may be executed within central processing unit (CPU) 120 to cause computing system 100 to perform the disclosed operations. In many known computer servers, workstations, PLCs, personal computers, mobile devices, and the like, CPU 120 is implemented in an integrated circuit called a processor.

The various illustrative logics, logical blocks, modules, and engines, described in connection with the embodiments disclosed herein may be implemented or performed with any of a general purpose CPU, a digital signal processor (DSP), an application specific integrated circuit (ASIC), a field programmable gate array (FPGA) or other programmable logic device, discrete gate or transistor logic, discrete hardware components, or any combination thereof, respectively acting as CPU 120. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is appreciated that, although exemplary computing system 100 is shown to comprise a single CPU 124, such description is merely illustrative, as computing system 100 may comprise a plurality of CPUs 124. Additionally, computing system 100 may exploit the resources of remote or parallel CPUs (not shown), for example, through local or remote communications network 110 or some other data communications means.

In operation, CPU 124 fetches, decodes, and executes instructions from a computer readable storage medium, such as HDD 122. Such instructions can be included in the software, such as the operating system (OS), executable programs/applications, and the like. Information, such as computer instructions and other computer readable data, is transferred between components of computing system 100 via the system's main data-transfer path. The main data-transfer path may use a system bus architecture 116, although other computer architectures (not shown) can be used, such as architectures using serializers and deserializers and crossbar switches to communicate data between devices over serial communication paths.

System bus 116 may include data lines for sending data, address lines for sending addresses, and control lines for sending interrupts and for operating the system bus. Some busses provide bus arbitration that regulates access to the bus by extension cards, controllers, and CPU 124. Devices that attach to the busses and arbitrate access to the bus are called bus masters. Bus master support also allows multiprocessor configurations of the busses to be created by the addition of bus master adapters containing processors and support chips.

Memory devices coupled to system bus 116 can include random access memory (RAM) 104 and read only memory (ROM) 106. Such memories include circuitry that allows information to be stored and retrieved. ROMs 106 generally contain stored data that cannot be modified. Data stored in RAM 104 can generally be read or changed by CPU 124 or other communicative hardware devices. Access to RAM 104 and/or ROM 106 may be controlled by memory controller 102. Memory controller 102 may provide an address translation function that translates virtual addresses into physical addresses as instructions are executed. Memory controller 102 may also provide a memory protection function that isolates processes within the system and that isolates system processes from user processes. Thus, a program running in user mode can normally access only memory mapped by its own process virtual address space; it cannot access memory within another process' virtual address space unless memory sharing between the processes has been set up.

The steps and/or actions described in connection with the aspects disclosed herein may be embodied directly in hardware, in a software module executed by a processor locally or remotely, or in a combination of the two, in communication with memory controller 102 in order to gain the requisite performance instructions. That is, the described software modules to perform the functions and provide the directions discussed herein throughout may reside in RAM memory, flash memory, ROM memory, EPROM memory, EEPROM memory, registers, a hard disk, a removable disk, a CD-ROM, or any other form of storage medium known in the art. Any one or more of these exemplary storage medium may be coupled to the processor 124, such that the processor can read information from, and write information to, that storage medium. In the alternative, the storage medium may be integral to the processor. Further, in some aspects, the processor and the storage medium may reside in an ASIC. Additionally, in some aspects, the steps and/or actions may reside as one or any combination or set of instructions on an external machine readable medium and/or computer readable medium as may be integrated through I/O port(s) 118, such as a “flash” drive.

In addition, computing system 100 may contain peripheral controller 126 responsible for communicating instructions using a peripheral bus from CPU 124 to peripherals and other hardware, such as printer 128, keyboard 130, and mouse 132. An example of a peripheral bus is the Peripheral Component Interconnect (PCI) bus.

One or more hardware input/output (I/O) devices may be in communication with hardware controller 118. This hardware communication and control may be implemented in a variety of ways and may include one or more computer busses and/or bridges and/or routers. The I/O devices controlled may include any type of port-based hardware (and may additionally comprise software, firmware, or the like), such as the disclosed sensors and equipment inputs/outputs, and can also include network adapters and/or mass storage devices from which the computer system 100 can send and receive data for the purposes disclosed herein. The computer system 100 may thus be in communication with the Internet or other networked devices via the I/O devices and/or via communications network 110.

Display 136, which is controlled by display controller 134, may optionally be used to display visual output generated by computing system 100. Display controller 134 may also control, or otherwise be communicative with, the display. Visual output may include text, graphics, animated graphics, and/or video, for example. Display 136 may be implemented with a CRT-based video display, an LCD-based display, gas plasma-based display, touch-panel, or the like. Display controller 134 includes electronic components required to generate a video signal that is sent for display.

Further, computing system 100 may contain network adapter 108 which may be used to couple computing system 100 to an external communication network 110, which may include or provide access to the Internet, and hence which may provide or include tracking of and access to the process data discussed herein. Communications network 110 may provide user access to computing system 100 with means of communicating and transferring software and information electronically, and may be coupled directly to computing system 100, or indirectly to computing system 100, such as via PSTN or cellular network 114. For example, users may communicate with computing system 100 using communication means such as email, direct data connection, virtual private network (VPN), or other online communication services, or the like. Additionally, communications network 110 may provide for distributed processing, which involves several computers and the sharing of workloads or cooperative efforts in performing a task. It is appreciated that the network connections shown are exemplary and other means of establishing communications links between multiple computing systems 100, and/or with remote users, may be used.

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

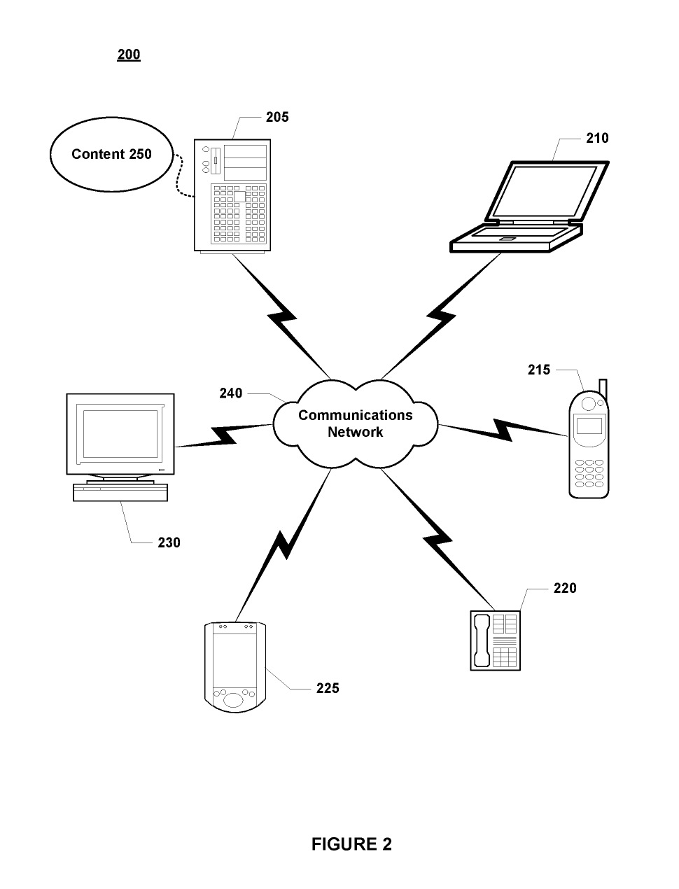

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

It is appreciated that exemplary computing system 200 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

In accordance with another aspect of the invention, reduced cost of credit may be offered to an account member. Based on the member's creditworthiness and standard market rates, for example, members may be offered an optional credit line (e.g., credit/charge card) at reduced rates (e.g., lower APR, reduced annual fees). Creditworthiness may be determined by a credit bureau using a FICO® score.

In an embodiment of the present invention, a card cash management system, preferably, debit card cash management system, may be available to a certain group members of a defined network. The defined network may include financial service providers, such as a bank or other money handling entity, and vendors of various types offering any manner of goods and/or services.

In an embodiment of the present invention, the defined network may be closed to unauthorized parties and may be established to increase the buying power or leverage of members. For example, as described herein, by providing members with a certain degree of certification, for example, vendors may provide one or more members with preferred pricing and/or other discounts based, in part, on member certification. The defined network may be controlled by a management entity which may, for example, allow for a valuable member experience, both through leverage over participating vendors and/or by allowing solicitation and/or gratis goods and services to be served to members.

In an embodiment of the present invention, participating members may earn a preferred rate (higher than standard bank rates) on deposits, for example, with at least one financial institution associated with the system. For example, such preferred rates may be indicative of a member's investment and or deposit with the system and or other member attributes. Similarly, vendors with the system, including the at least one financial institution, may provide to certain members a seamless, point-to-point sales solution across all related vendors and/or other members For example, the present invention may also provide at least one new layer of commonality and/or connectedness for members to their favorite vendors, locations, and or other members.

In addition to other services offered through the system, members may be provided a credit, charge or debit card having a low cost of credit compared to standard market rates, and cross collateralized with a financial account held by the member within the system. As may be understood by those skilled in the art, a third party credit score of a member, such as a FICO score, maybe taken into account when setting the cost factors related to a credit, charge or debit card, and/or any lending of credit to a member. Such as to credit may, for example, be included in membership into the system and may be built into membership cards, creating an effortless end-to-end member experience. As would be appreciated by those skilled in the art, the system may provide any number of additional services to its members. Such ease of use and connectivity to members may provide increased member affinity to the system as the member card and account are used for other purchases.

In an embodiment of the present invention, the system may allow for automated debit initiation, annual, and/or on-site fees, for example, in connection with the member's use of system resources, such as, for example, vendors and or other marketplace participants. Similarly, members may have instant access to cash, credit lines, and other financial instruments. In an embodiment of the present invention, fees charged for use of the system, and, more particularly, fees charged in association with a credit, charge or debit card issued within the system, may be lower than outside the system and/or absent member participation. For example, general credit card fees may be lessened and/or eliminated.

In an embodiment of the present invention, attributes of members may be collected and/or tracked and may be used within and/or outside the system to improve inter-system access and usage by members and to, for example, deliver targeted ads and/or solicitations to at least one member. Such behavioral information may, for example, track what and where members, and/or prospective members, including guests, are transacting, both at a system included vendor and outside the system. Such tracking may increase the effectiveness of targeted marketing.

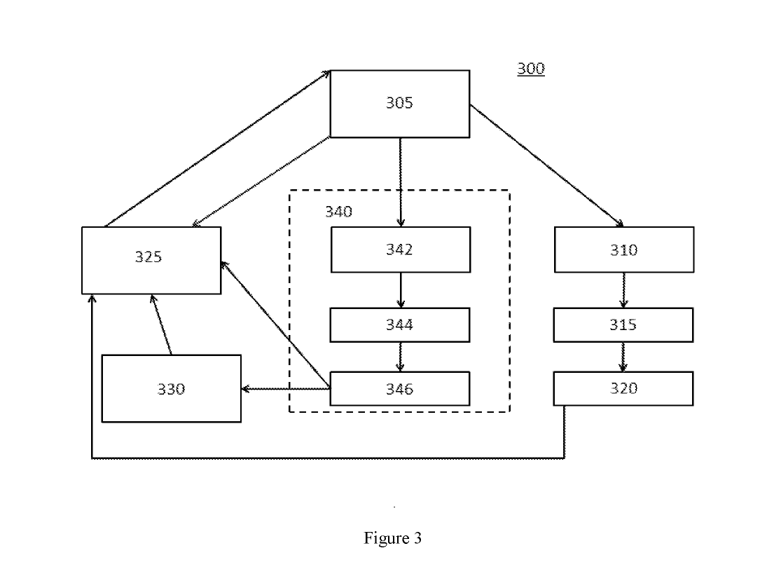

As illustrated in FIG. 3, system 300 may include member access point 305 which, through a traditional physical key card or an app or other internet connected device/program, may connect a member with various system 300 services. Access point 305 may provide direct and secure access to bank 325 where, for example, a member may deposit and withdraw funds, access information related to the use of those funds, such as rewards tracking, and may, for example, obtain credit instruments, such as a loan, and credit, charge and debit cards, for example. Bank 325 may be accessible by a member through a system validated debit card and/or a member authorized card (which may be virtual as discussed above) and may provide for the fluid movement of monies and credit within the system.

A member using the system may present system credentials, which may be in the form of a rewards card, may be used within at least one internal system processor 340 which may include, for example, a POS terminal 342 which may be associated with one or more vendors registered as users of the system 300 and, more particularly, are authorized to provide member benefits as detailed above. Use interactions at a POS terminal 342 may be cataloged by tracking engine 344 which may be in further communication with gateway engine 346. Communication outside of internal system processor 340 may be facilitated through gateway engine 346 and may allow access to bank 325 and rewards engine 330. Access to bank 325 may allow for system processor 340 to credit and/or debit a member bank account in accordance with member activity at a vendor as indicated by POS terminal 342. Similarly, reward calculations may be processed by rewards engine 330 in accordance with rules provided by the system and in accord with a particular member and may provide a calculation of such rewards to bank 325.

An indication of a reward total for a member may, for example, be provided by to POS terminal 342 to allow a member to know how many points/rewards have been accumulated. This may allow for the use of point/rewards by a member through system processor 340 for value to the vendor. Processing of points/rewards may follow the same pathways as described for monies housed in bank 325, for example.

Third party vendors may also participate in aspects of system 300 through POS 310. External tracking engine 315 may allow for the recording of third party vendor interactions and may utilize a gateway engine 320 to communicate with bank 325. The gateway engine 320 may be a cloud-based interaction server which may provide secure communications between bank 325 and tracking engine 315 and/or POS 310. In this way, all usage of a debit and/or credit card issued to a member may be tracked by system 300.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

I claim:

1. A computer-implemented engine for generating a reward, over a network, responsively to input member information, comprising:
a member access point communicatively coupled to a graphical user interface, wherein the member access point is configured to:
receive credentials presented by at least one member;
locally query a reward engine for input member information based at least in part on the credentials; and
provide at least one verified reward based on a response from the reward engine.

2. The computer-implemented engine of claim 1, wherein the input member information comprises at least one of:
general member information;
member financial information; and
certified member input.

3. The computer-implemented engine of claim 1, further comprising:
at least one network port capable of remotely receiving the member information from said graphical user interface.

4. The computer-implemented engine of claim 3, further comprising:
at least one financial account communicatively connected to said at least one network port, and comprising a cash management engine;

5. The computer-implemented engine of claim 4, the reward engine further comprising:
at least one rules engine communicatively connected to said at least one network port, and comprising a plurality of rules to generate, responsively to the input member information and to an indication from the cash management engine, the at least one verified reward.

6. The computer-implemented engine of claim 5, further comprising:
at least one notification engine communicatively coupled to the at least one rules engine and configured to reporting to the at least one member the at least one verified reward;

7. The computer-implemented engine of claim 1, wherein member access is provided on a subscription basis.

8. A computer-implemented engine for generating a reward, over a network, responsively to input member information, comprising:
a member access point communicatively coupled to a graphical user interface, wherein the member access point is configured to:
receive credentials presented by at least one member;
locally query a reward engine for input member information based at least in part on the credentials; and
provide at least one verified reward based on a response from the reward engine.

9. The computer-implemented engine of claim 8, wherein the input member information comprises at least one of:
general member information;
member financial information; and
certified member input.

10. The computer-implemented engine of claim 8, further comprising:
at least one network port capable of remotely receiving the member information from said graphical user interface.

11. The computer-implemented engine of claim 10, further comprising:
at least one financial account communicatively connected to said at least one network port, and comprising a cash management engine;

12. The computer-implemented engine of claim 11, the reward engine further comprising: at least one rules engine communicatively connected to said at least one network port, and comprising a plurality of rules to generate, responsively to the input member information and to an indication from the cash management engine, the at least one verified reward.

13. The computer-implemented engine of claim 12, further comprising:
at least one notification engine communicatively coupled to the at least one rules engine and configured to reporting to the at least one member the at least one verified reward;

14. The computer-implemented engine of claim 13, wherein member access is provided on a subscription basis.
